(19) United States
(12) Patent Application Publication
(10) Pub. No.: US 2014/0258816 A1
(43) Pub. Date: Sep. 11, 2014

(54) METHODOLOGY TO DYNAMICALLY REARRANGE WEB CONTENT FOR CONSUMER DEVICES

(71) Applicants: True Xiong, San Diego, CA (US); Charles McCoy, Coronado, CA (US)

(72) Inventors: True Xiong, San Diego, CA (US); Charles McCoy, Coronado, CA (US)

(21) Appl. No.: 13/790,273

(22) Filed: Mar. 8, 2013

(51) Int. Cl. G06F 17/21; G06F 17/22

(52) U.S. Cl. CPC G06F 17/211; G06F 17/2235
USPC 715/201; 715/239; 715/205

(57) ABSTRACT

Systems and methods are provided that convert or transform web-based content and pages and dynamically rearrange such content in pages in such a way that the presentation is native or highly convenient to customers already familiar and conditioned to use embedded, network-enabled devices such as IPTVs, media players such as Blu-ray® players, game consoles such as the PS3® game console, network boxes, and the like. Users can employ various user input devices to navigate webpages just as they would other content on the network-enabled device. The user input device may vary, but may include remote controls, second displays, mobile phones, laptop computers, devices for the disabled, and so on.

### BACKGROUND

Web browsers are becoming common features in consumer electronics devices. However, little to no progress has been made in making web-based content or pages intuitive and easy to navigate and use on such devices. The user experience of browsing the web is difficult and cumbersome on many consumer electronics devices, causing many customers to withdraw from future use. Moreover, current web content and pages are generally not designed for consumer electronics devices, especially embedded devices such as IPTVs and media players.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Systems and methods according to present principles involve the conversion or transformation of web-based content and pages and dynamic rearrangement of such content in pages in such a way that the presentation is native or highly convenient to customers already familiar and conditioned to use embedded, network-enabled devices such as IPTVs, media players such as Blu-ray® players, game consoles such as the PS3® game console, network boxes, and the like. Within the context of this description, the term web-based content can be applied to, e.g., still images, videos, other audiovisual images, text, and other items that may appear on a webpage. The term webpage generally applies to a container that is being rendered by a browser renderer.

The systems and methods may generally employ three stages. A first stage involves real-time processing of web content or pages. A second stage is the conversion, translation, and transformation of this web content or pages. A third stage is the mapping of normal web navigation with native embedded device navigation.

In one implementation, a first step is to acquire information about the user input device being used, e.g., via a backend call to a database on a server, or from the user input device itself. Such may include information about what buttons or other inputs are available in the user input device for remote control of the consumer electronics device. Range or web requests may then be performed to determine the size of the webpage. Webpages may then be downloaded to allow analysis of content. Using the known device capabilities and the user input device information, the web content and webpage may be dynamically converted, translated, and/or transformed. The content inside the webpage may be segmented by content types, characters, and the like. The webpage may be rearranged from a vertical navigation viewing scheme to a horizontal one. The rearranged web content in the page may then be displayed to users. Users can seek back or forward to view the web content or page just as they would during content playback. Users requiring special accessibility can zoom in and out of the web page using the user input device.

The user input device is defined as a device that may be employed to control actions on the network-enabled device through the network-enabled device's native user interface. The user input device may be any of a number of devices employed to control actions on the network enabled device. For example, the user input device may be a remote control, a second display, a touchscreen device, a game controller, or even navigation buttons on the device itself. To address the needs of people with disabilities, the network-enabled device's native user interface may be controlled by other appropriate user input devices as needed, e.g., a tube that can cause a user interface to respond to a user's inhalation or exhalation.

In one aspect, the invention is directed towards a method of displaying webpages and content on a network-enabled device, including: on a network-enabled device having a navigational scheme, receiving a webpage having web content displayed in a web format and a means for navigation; converting the display format of the web content to a format appropriate for the network-enabled device and converting the means for navigation to the navigational scheme; and displaying at least a portion of the converted content.

Implementations of the invention may include one or more of the following. The network-enabled device may have a predetermined format for display of content, and the converting may include converting the display format of the web content to the predetermined format. The converting a means for navigation may include mapping the means for navigation onto a navigational scheme corresponding to an IPTV, media player or game console. The format appropriate for the network-enabled device for display of content may include displaying thumbnails of available image, audio, or video files in a matrix, and the converting the display format of the web content to a format appropriate for the network-enabled device may include positioning thumbnails of the available image, audio, or video files from the web page on the matrix, such that a user input device associated with the network-enabled device may be employed to navigate between the thumbnails and to select a thumbnail for display. The converting the display format may further include sizing thumbnails according to their size on the webpage, or may further include playing back a slideshow of at least a portion of the images and/or video files on the webpage. If a thumbnail of an image, audio or video file is automatically selected on the webpage, then the method may further include automatically selecting the same image or video on the matrix. In another way, the format appropriate for the network-enabled device for display of content may include displaying a list of text-based representations of available image, audio, or video files, and in this case the converting the display format of the web content to a format appropriate for the network-enabled device may include positioning the text-based representations of the available image, audio, or video files from the web page in a list, such that a user input device associated with the network-enabled device may be employed to navigate between the representations and to select a representation for display. The text based representations may be links or menu items. The web content may include at least one link, and the method may further include following the at least one link to determine additional information about a corresponding content item, and displaying an indicator of the content item. The webpage may have web content displayed in a web format including a plurality of standard links, and the converting may include mapping the standard links to a common section on the predetermined format. The method may further include arranging the conversion of the means for navigation to the navigational scheme such that the user input device can control targeting of the links. If the web content includes text, and the network-enabled device has a 3-D capability, then the method may further include using the 3-D capability to make the text appear closer to the user than on a display of the network-enabled device. In another way, if the web content includes text, the converting may be performed such that the text is prominent and does not wrap around images. If a second display is being used to control content on the network-enabled device, then a display of content on the network-enabled device may be emphasized corresponding to the content on the second display. The converting step may include filtering the web content such that the displayed converted content corresponds to only that which is capable of being rendered on the network-enabled device. The converting may include filtering the web content such that only a selected type of content is displayed, and the filtering may be in response to a user request. The converting may employ using metadata in the webpage. The method may further include receiving conversion settings from a server. The converting may further include replacing cursor functionality on a webpage with user input functionality, such as functionality of a remote control. The displaying at least a portion of the converted content may further include displaying any translated content from right to left. The displaying may further include displaying converted content in a manner native or consistent with a manner the network-enabled device displays other content. The converting the means for navigation to the navigational scheme may include mapping a browser NEXT button to a fast-forward button, and a browser back button to a REWIND button. The web format of the web page may be a standard format having a common set of parameters for conversion, and may further include converting the display format according to the common set of parameters, e.g., where the standard format is a storefront or wiki. The displaying may include displaying a first portion of a web page following the converting, and further displaying a link, and further including displaying at least a portion of a remainder of the web page in response to user activation of the link.

In another aspect, the invention is directed towards a non-transitory computer-readable medium, including instructions for causing a computing device to perform the above method.

In yet another aspect, the invention is directed towards a method of displaying webpages and content on a network-enabled device, including: on a network-enabled device, determining characteristics of a user input device; performing a range request to find out a size of a webpage; downloading the webpage; using the determined characteristics of the user input device and device characteristics of the network-enabled device, dynamically translating and transforming the webpage; and displaying the transformed webpage.

Implementations of the invention may include one or more of the following. The method may further include segmenting the content inside the webpage by content type. The determining characteristics of the user input device may be performed by making a backend call to a database or by sending a request to the user input device. The dynamically translating and transforming may include rearranging the webpage from a vertical navigation viewing scheme to a horizontal navigation viewing scheme.

In yet a further aspect, the invention is directed towards a method of displaying webpages and content on a network-enabled device, including: receiving notification that a network enabled device has requested a webpage, the network-enabled device having a navigational scheme, and the webpage having web content displayed in a web format and a means for navigation; converting the display format of the web content to a format appropriate for the network-enabled device and converting the means for navigation to the navigational scheme; and transmitting at least a portion of the converted content to the network enabled device for display.

Advantages of certain implementations of the invention may include one or more of the following. The systems and methods overcome the disadvantages of the prior art and allow web-based content and pages to be easily navigated on consumer electronics and other network-enabled devices. In many cases users need only be able to operate their user input device to effectively navigate webpages. Using the systems and methods according to present principles, the user experience is preserved and a solution provided to the otherwise cumbersome experience of navigating and browsing the web on an embedded device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an exemplary implementation according to present principles, showing a conversion of browser window contents to a format appropriate for a consumer electronics device.

FIG. 2 illustrates another exemplary implementation according to present principles, where the browser window contents are converted to a different format appropriate for a consumer electronics device.

FIGS. 3(A) and 3(B) illustrate other exemplary implementations according to present principles, in which text on a webpage is converted to various formats appropriate for a consumer electronics device.

FIG. 4 is a flowchart illustrating a method according to present principles for converting browser window contents to formats appropriate for a consumer electronics device.

FIG. 5 is another flowchart illustrating a method according to present principles, for a specific implementation of the present principles.

FIG. 6 illustrates an exemplary computing environment, e.g., that of the disclosed second display, server, consumer electronics device, network-enabled device, or the like.

Like reference numerals denote like elements throughout.

### DETAILED DESCRIPTION

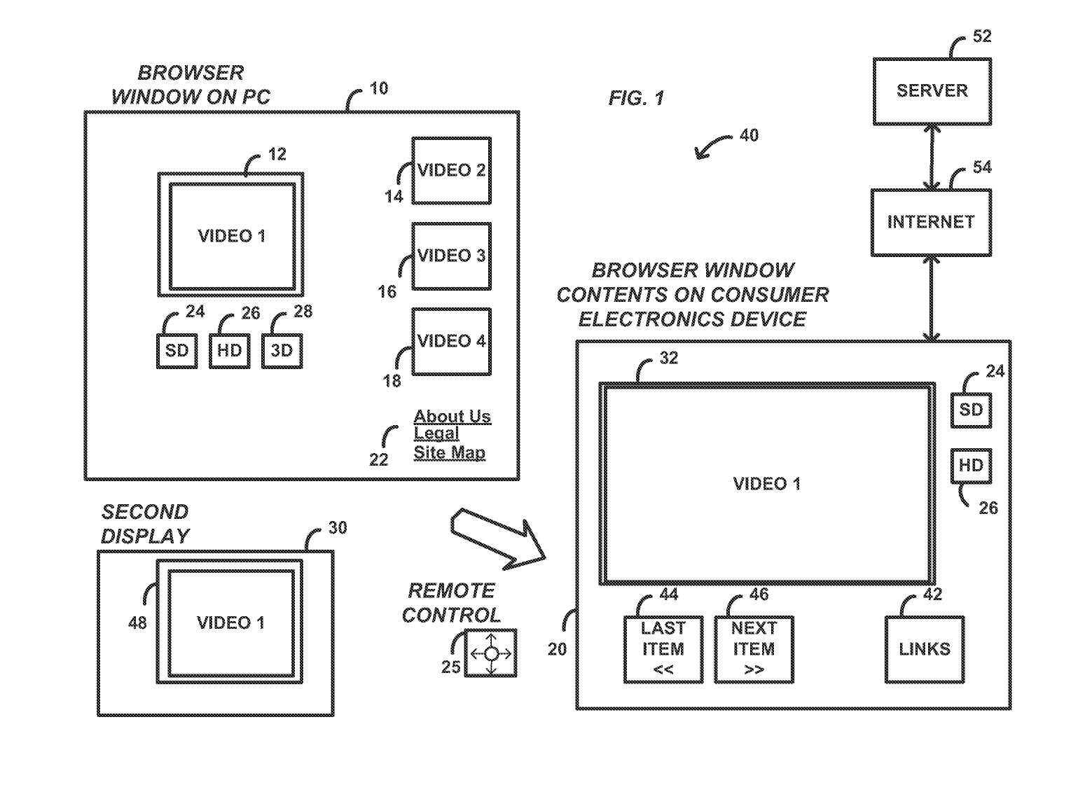

Referring to FIG. 1, an exemplary system 40 is illustrated in which a method according to present principles may be employed. In the system 40, contents of a browser window 10 art to be displayed on a consumer electronics device 20, e.g., IPTV as well as other such devices including Blu-ray® players, which have an output to a display. Control of the consumer electronics device 20 may be via various methods, including a user input device 25. The user input device 25 can be used to enter some simple data but are generally more useful for navigating using functions such as arrow keys and a select button.

In the prior art, the contents of the browser window 10 were presented on the consumer electronics device 20 by using the device 20 simply as any other display, i.e., without any additional format. Thus, browser contents would be reproduced on the device 20. As, e.g., the aspect ratio may differ between the devices, a degree of scrolling would often be necessary, up and down or right and left, to see the whole page.

In the case of FIG. 1, the browser window 10 includes a prominently displayed video 12, as well as several less prominently displayed videos 14-18. A variety of buttons are provided for selecting the quality of the video 12, e.g., a standard definition (SD) button 24, a high definition (HD) button 26, and a three-dimensional (3D) button 18. Various standard links 22 are also shown. Generally the webpage has web content displayed in a web format, as well as a means for navigating the content, e.g., a cursor.

In systems and methods according to present principles, the contents of the browser window 10 may be reformatted and/or rearranged for presentation and display on the consumer electronics device 20. In so doing, the contents of the browser window may be formatted or arranged in a way that is appropriate for the device and suited for its navigational scheme, e.g., to allow content selection by a user input device such as a remote control. For example, the contents may be situated in a way that is given to being navigated using a typical remote control, e.g., where contents, or icons thereof, may be navigated between using simple up/down and right/left buttons, as well as a select or enter button. In another implementation, the reformatting may be so as to allow navigation with a user input device having a touch-screen user interface. In certain such implementations, certain effects may be less appropriate than in a typical browser window, such as roll-over effects.

Alternatively, the conversion of contents may be such that contents are mapped to a predetermined format, such as the native menu system or standard interface of the consumer electronics device. For example, some consumer electronics devices have menu systems similar to those of computers, where menus drop down from the top or expand out from the right or left side. Such menu systems are innately configured to be navigated by a user input device such as the remote control provided with the device. Thus in one implementation, contents on a webpage may be formatted to take advantage of the native navigation functionality, e.g., of such menu systems. The links and/or media items of a web page can appear as menu items in the device's native menu system. Other consumer electronics devices may employ other content display and navigation paradigms which may be utilized, such as cross media bars, and the like. In any case, converting the means for navigation of the browser window 10 may include mapping the means for navigation onto a navigational scheme of the consumer electronics device, which may be an IPTV, media player such as a Blu-ray® player, game console, or the like.

In many implementations, a primary usage of consumer electronics devices to browse websites will be for the searching and subsequent displaying of found media items such as videos, images, text, and in some cases audio content. Accordingly, conversions will often be done so as to make such content prominent and easy-to-navigate on the consumer electronics device.

Certain specific transformations may be seen. For example, in some implementations, a consumer electronics device interface will not have a cursor, and so the function of the same in the browser window will be converted to equivalent functionality, e.g., using arrow buttons on common user input devices. The aspect ratio may change, and such may be determined not only by analysis of the webpage but on the known characteristics of the consumer electronics device. In many cases, a vertical navigation scheme may be converted to a horizontal one. Information about webpage display characteristics and navigation may be transmitted via metadata in the HTML file, and the same may be used in the conversion.

In another implementation, instead of using a cursor to navigate around the website to select content items, the most prominent content item may be displayed, e.g., VIDEO 1, and other content items may be navigated to with “LAST ITEM” and “NEXT ITEM” buttons 44 and 46, respectively, which may be mapped to “REWIND” and “FAST FORWARD” buttons on the remote control respectively.

The set of standard links 22 in the browser window 10 may be accessed with a LINKS button 42, which upon targeting and activation may display in a common section the contents of all links 22 together (due to the typically larger screen size of the device 20) or repeated activations of the LINKS button 42 may toggle between the entries. Many variations of this concept will be seen. For example, links may be converted and rearranged based on user preferences. Some users may not desire to see such standard links when merely browsing video content. Analysis of what constitutes a standard link may be by way of textual analysis, e.g., analyzing the HTML code or words and identifying phrases such as “site map”, and the like. In other variations, the links from a web page may be grouped based on how they are grouped on the web page, e.g., it is common to place a number of links in the footer or header of a page by grouping them together in div elements positioned in these areas. Similarly, navigation bars along the left and right edges of the page are common, while other links will be in the body of the main content. It is important to note that this conversion is not simply displaying the browser window on the consumer electronics device display: it still involves a conversion, to adapt the placement of the links to the size and shape of the display, as well as to accommodate the placement of the other converted elements.

The contents of the browser window 10 may be filtered prior to conversion and display on the consumer electronics device 20. For example, the content may be filtered based on the capability of the device for playback, e.g., what codecs are available. In a specific example, if the device 20 cannot playback 3-D video, there would be no need to display the option for a 3-D version of a content file. In this case, while options 24-28 are provided on the browser window 10, only options 24 and 26 need be provided on the device 20. A device that has a display that is only capable of displaying a few lines of text would not display any images or background colors from the web page. Content may also be filtered based on user choice, e.g., based on ratings, type of content, length, author, actor, or the like, or combinations of these.

Systems and methods may be particularly applicable to current web content as much of such content is moving toward standardization, generally and within certain categories. For example, most wikis have a common format. Certain highly popular websites, such as Amazon.com®, may have one or more sets of conversion settings defined for various devices, and the same may be used and/or stored for the many visitors of such sites. If the consumer electronics device 20 does not already have settings stored, when such a site is visited, appropriate settings may be received from a server 52 through the Internet 54 upon a call or request. Standard conversions may be configured for photo sharing sites, social networking sites, and the like. Moreover, besides having parsing and conversion specific to particular web sites or popular page formats, the parsing and conversion can also recognize popular web development libraries, such as JQuery® and MooTools, and have wrappers or other actions specific to the use of those libraries.

It is also noted that the conversion of the webpage may occur in the device that is rendering the webpage, or may occur in a server so that the converted page is downloaded to the device. Certain advantages inure to each of these. If the device does the processing, then no third-party or other external entity needs to be involved in the browsing. If the server does the processing, then it may be convenient to maintain a large library of conversions, specific to websites and web software, up-to-date on the server, and in this case there may be only a single copy of such conversion rules instead of a copy on each device.

As noted, control of the viewed contents on the consumer electronics device 20 may be by way of a second display 30. In FIG. 1, the second display 30 is shown selecting a video 48, VIDEO 1, and the same is illustrated displayed and selected on the consumer electronics device 20 as video 32. Generally content displayed on the second display, which is often a subset of that displayed on the consumer electronics device, may be emphasized on the device, e.g., by making more prominent, making the text or image larger, or in other ways as described below.

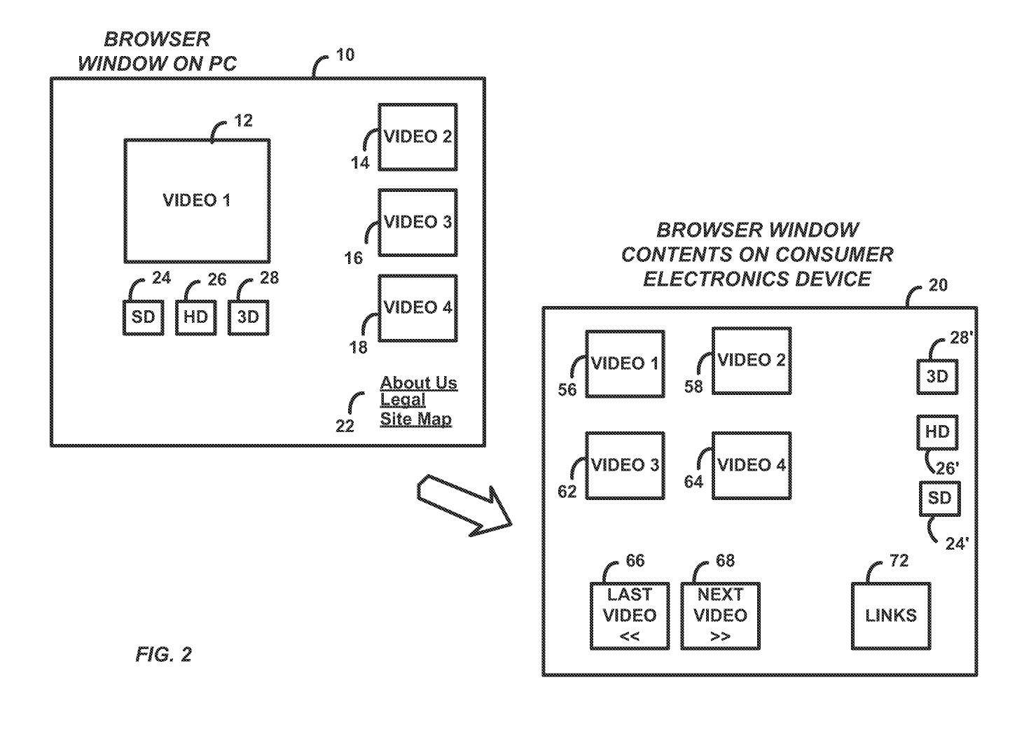

Referring now to FIG. 2, an alternative embodiment of a conversion technique is illustrated. In FIG. 2, the contents of browser window 10 are illustrated on the consumer electronics device 20 by a matrix of icons or thumbnails, each icon or thumbnails corresponding to an item of content on the browser window 10. For example, the videos on browser window 10 are illustrated by thumbnails 56-64 on device 20. Such thumbnails may be easily navigated by a user input device associated with the device 20. The thumbnails may be provided with the video content or may be created on the fly while other portions of the page are being generated for display on the device 20. For example, a thumbnail may be generated by analyzing a first portion of data of a given video file. In a specific implementation, the thumbnails may be sized in such a way as to correspond to their prominence in browser window 10. For example, larger content windows within browser window 10 may be afforded larger windows for display within the consumer electronics device 20. A matrix of thumbnails or icons is generally well-suited to navigation via typical user input devices, and thus converting the display format of the web content by creating and positioning thumbnails of the available image or video files in a matrix on the device 20 provide significant benefits to the user. The user may navigate between the thumbnails and select the thumbnail for display and playback as a full-size video.

As noted with respect to FIG. 1, a selected video made be directed to play in various modes, such as SD, HD, or 3-D, via buttons 24′, 26′, and 28′ respectively. In some cases 2D video within the browser window 10 may be converted to 3-D video on the consumer electronics device 20, assuming the same is supported.

As noted above, the user input device may navigate between thumbnails in a convenient fashion. Other common buttons on the user input devices such as remote controls, such as a REWIND button or a FAST-FORWARD button, may also be employed to move between content files. These are indicated by screen buttons 66 and 68, respectively. A user may either press REWIND or FAST-FORWARD on the remote control, or navigate to the displayed icons, to accomplish the desired functions. As noted before, a LINKS button 72 may be provided to access standard links on the webpage.

In an alternative implementation, links from a webpage can be followed to see if there are prominent media there that may be included in the converted page's media navigation. For example, a webpage may have a link to a media file. When the link ends with a popular suffix, such as .mp3, .jpg, or .mpeg, a guess may be made as to what type of media is likely to be returned by the link. Certain links do not have suffixes corresponding with the format of what will be returned, and thus will need to be requested to determine their contents. A HEAD request may be made to see what content type is indicated in the response header. Alternatively, a request may be made, which can be terminated after the first portion of data is received, to determine what will be returned. In the case where another webpage is returned, the webpage can be parsed to see if there are prominent media on that page. For example, a webpage may contain a series of links to other pages, each of those other pages featuring a single media element, with navigation elements wrapped around the media content.

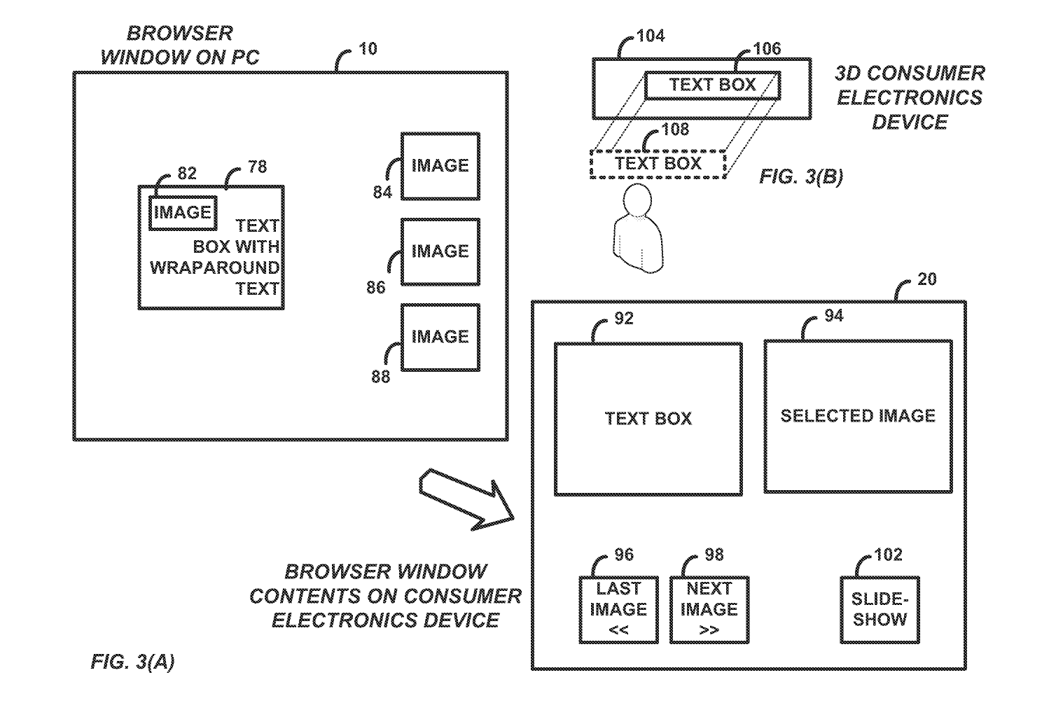

Referring to FIG. 3(A), in some cases the contents of browser window 10 may include a text box 78, which may or may not wrap around an image 82. Other images 84-88 may also be displayed on the browser window. On the consumer device 20, a format appropriate for display of such a text box may include a separate and/or enlarged text box 92 corresponding to the box 78, with a separate and/or enlarged image 94 corresponding to the image 82. In this way, reading may be made more convenient for a user with the text unwrapped around the image. In the same way as in FIG. 2, navigation between images displayed may be via REWIND or FAST-FORWARD buttons 96 or 98, respectively. A slideshow of images may be provided by a button 102.

Text may be scaled based on the size of the display the page will be shown on. For example, text may be scaled to a larger font size when it will be displayed on a large television screen, while thumbnails may be scaled down when they will be displayed on a device with a small screen.

In yet another implementation, blocks of text may be displayed in a scrolling area when they were displayed fully on the original page, and vice versa. In an alternative embodiment, shown in FIG. 3(B), and particularly suited for consumer electronics devices 104 adapted for 3-D, a text box 106 may have a stereo eye created for it such that, when viewed by a user, the text box 106 appears at a position 108 close to the user. In this way reading text on a screen is made significantly more convenient. In some cases, the text may appear closer while the image appears at the position of the screen. In other implementations, both text and images appear closer to the user. Other variations will also be understood.

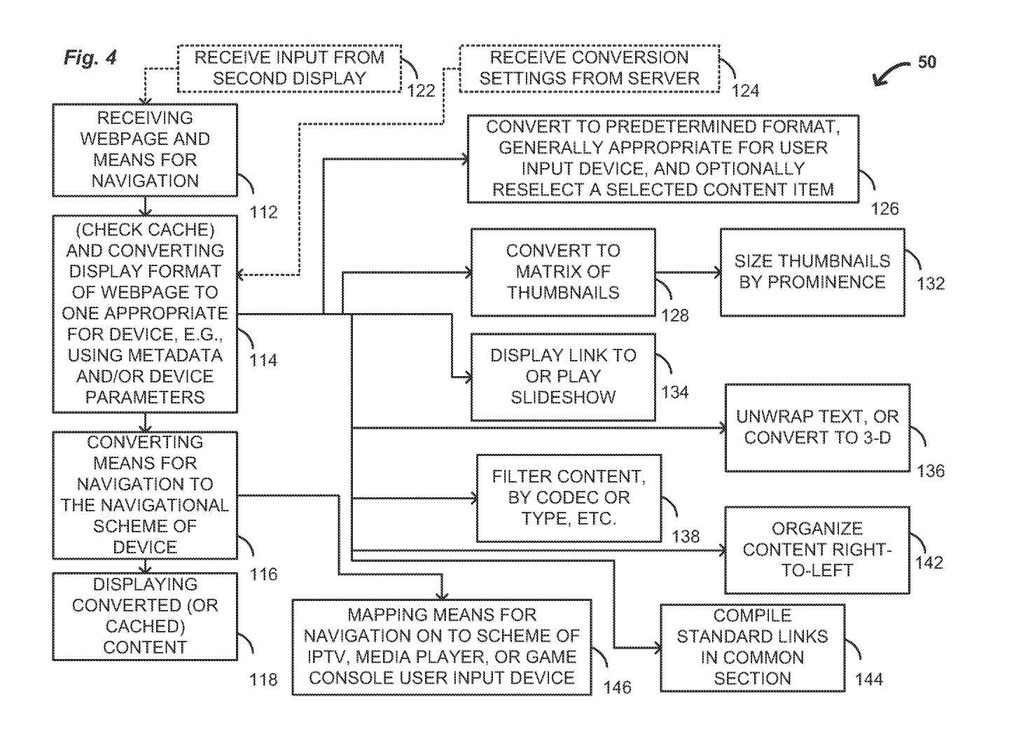

FIG. 4 illustrates an exemplary flowchart 50 implementing various aspects described. In a general method, the flowchart begins with receiving a webpage and a means for navigation (step 112). Such a step generally involves the user navigating to a webpage via a link, entering a URL in an address field, or the like. Other ways will also be understood, including receiving information from a second display (step 122). Receiving a means for navigation need not entail a separate step, but may simply entail receiving an HTML file representing a webpage which has means for navigation inherently included. Usually, a means for navigation includes use of a pointer or cursor, the tab button to move between entries, arrow keys on a keyboard, or the like.

In some cases, if a way of converting the webpage is not already stored, conversion settings may be received from a server (step 124). Otherwise, the conversion may proceed in the next step dynamically, converting the website according to determined techniques for appropriate display on the consumer electronics device, using device information such as capabilities, a profile, or the like.

As noted, the next step is to convert the display format of the webpage to one appropriate for the consumer electronics device (step 114). In an implementation as noted above, this step may include checking an available cache in order to receive cached content, improving performance. In another implementation, metadata may be supplied with the webpage that drives or at least informs the conversion. The conversion may proceed in a number of ways. For example, in one case, the conversion is to a predetermined format (step 126). The predetermined format may include a standard interface of the consumer electronics device, and the same is generally appropriate for navigation via a user input device. Where an item is selected on the webpage, the same item may be selected on the consumer electronics device.

In another implementation, the server that delivers content to the consumer electronics device may determine the most essential web content to display first. In some cases, such data will come from business information data regarding which content the user browses, navigates to, and/or selects on the device. Such may then inform what data is converted first and thus enables a rapid display of content on the device. For example, if the device is a home audio device that supports only three lines of text, the metadata may be analyzed first, to the exclusion of graphics. In another example, if the device is a low-end HDTV, the graphics will also be substandard, and the conversion logic may begin by: receiving metadata, and instigating another thread in parallel using another server to retrieve graphics for conversion as appropriate. Knowing the connection speed of the consumer electronics device, the graphics may be resized appropriately.

Returning to the flowchart, conversion to a predetermined format, a plurality of contents on the webpage may be converted to a matrix of thumbnails or icons, the same associated with items of content on the webpage (step 128). In some cases, the thumbnails or icons may be sized according to prominence on the originating webpage (step 132). For example, if a particular item of content is occupying most of the window, the same may be assumed to be of high interest to the user, and may be placed in a position of prominence on the display of the consumer electronics device. Where the webpage includes a number of content items, a link may be displayed to access or to play a slideshow of the respective items (step 134).

Where a significant amount of text is displayed, especially in a text box wrapping around images, the text may be unwrapped and presented prominently for easy reading on a consumer electronics device (step 136). If the device has a 3-D capability, the text images may be modified by the creation of a stereo eye to allow the user to read text that appears to be closer to their eyes than is the device itself. In this way, reading text on a consumer electronics device, previously a difficult experience, may be made significantly more convenient.

In a related implementation, if 3-D glasses worn by the viewer are configured to vary from viewer to viewer, different viewers may look at the same page on the device and yet see and read different text and images.

In another implementation, content from the webpage may be filtered based on the ability of the device to play back the content, e.g., based on hardware characteristics and available codecs (step 138). In a related implementation, the content displayed on the consumer electronics device from the browser window may be filtered in other ways, such as by content type, rating, actor, director, studio, author, and so on.

The conversion can do more than just rearrange images and text. In some advanced conversions, where a configured language of viewer is of a type which is read from right to left, such may inform the arrangement of images and text. Menu items and icons may be situated as to more naturally read from right to left (step 142), thus giving a degree of comfort to viewers who are used to such layouts.

As noted previously, standard links may be compiled into a common section (step 144), allowing the viewer to access the same when desired, but not to unduly impede viewing of media content otherwise.

Following or contemporaneous with converting the display format of webpage content, the means for navigation of the webpage may be mapped to the navigational scheme of the device. For example, the means for navigation may be mapped onto the navigational scheme of an IPTV, a media player, or game console (step 146). Other ways of mapping are described above.

Finally, once the conversions have been accomplished, the converted content may be displayed (step 118).

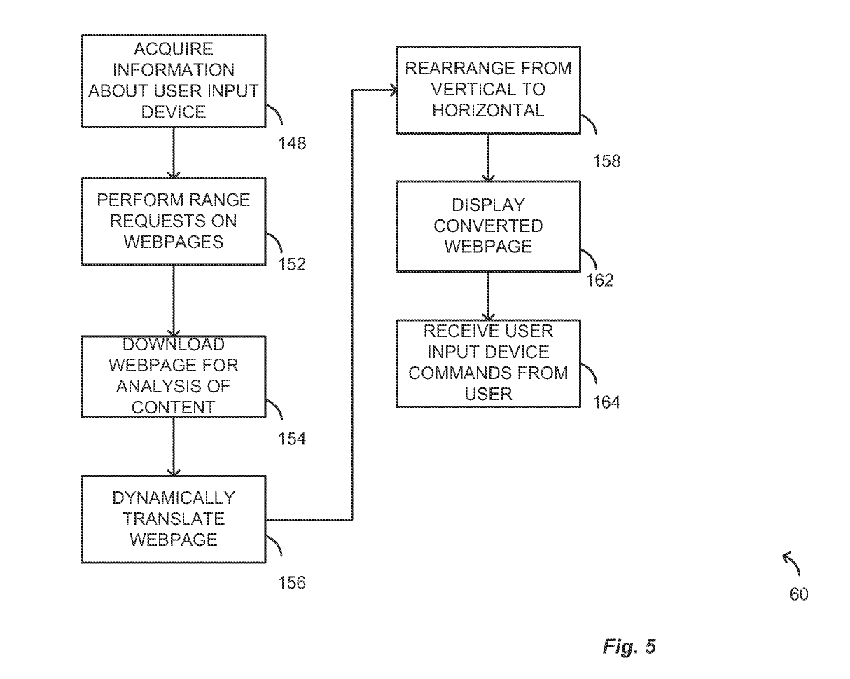

FIG. 5 is a flowchart 60 illustrating a specific implementation of the present principles. In flowchart 60, a first step is to acquire information about the user input device (step 148). Such information may be newly obtained or may be retrieved from memory or other persistent storage. In one implementation, such information is obtained via a backend call to a server database. This step allows the system to obtain information about ways the system is configured to navigate.

A next step is to perform range requests on webpages (step 152). In this way, the system may obtain information about the size of the webpage.

The webpage may then be downloaded for analysis of its content (step 154). The webpage may then be dynamically translated, transformed, or converted (step 156), using known device capabilities and the information obtained about the user input device. In one implementation, content inside the webpage is segmented by content types, characters, or the like. In a common conversion technique, flow in the webpage may be rearranged from vertical to horizontal (step 158). Following such conversion, arrow buttons on the user input device, or trick play buttons, may be configured to navigate between content items. The converted webpage may then be displayed (step 162).

A viewer may then use the user input device to transmit commands to the device (step 164). For example, the viewer can seek back or forward to view the webpage just as they would during content playback. Where desired, and especially where disabled viewers employ accessibility options, viewers may zoom in or out of the webpage according to their needs for content consumption.

In any of the implementations discussed above, to improve the conversion and loading of web pages or content on the consumer electronics device, certain other methods may be employed. For example, converted web pages or content may be cached within local memory storage, a LAN storage drive, or on a server in network communication with the device. In this regard it is noted that future consumer devices will generally have significantly larger memories. In addition, for each web element that is converted, a determination can be made as to whether the element is static or dynamic, e.g., a dynamic element may include headline metadata that changes often over time. Static elements may include, e.g., branding elements, that do not change significantly over time. Through this separation of static and dynamic elements, a determination can be made as to which to cache. Then prior to making a request for the actual website and content, the consumer electronics device can check caches available to it for cached content.

In addition, based on a user's browsing history, the server from which the consumer electronics device receives content may review or “crawl” websites routinely to keep its caches up-to-date. From time-to-time, the server may cross-reference the websites it reviews against those websites that the user still actually visits from its browsing history. Such actions help improve the accuracy of the review and at the same time maintains the current status of the caches the user is most likely to access.

Systems and methods have been disclosed that allow improvement of the user experience of consumer electronics devices without adding to the hardware costs of the unit. As disclosed above, systems and methods according to present principles allow the convenient and desirable presentation and display of browser window contents on a consumer electronics device. The presentation and display are arranged in ways that are better suited to the user interface of a consumer electronics device, including its navigational scheme.

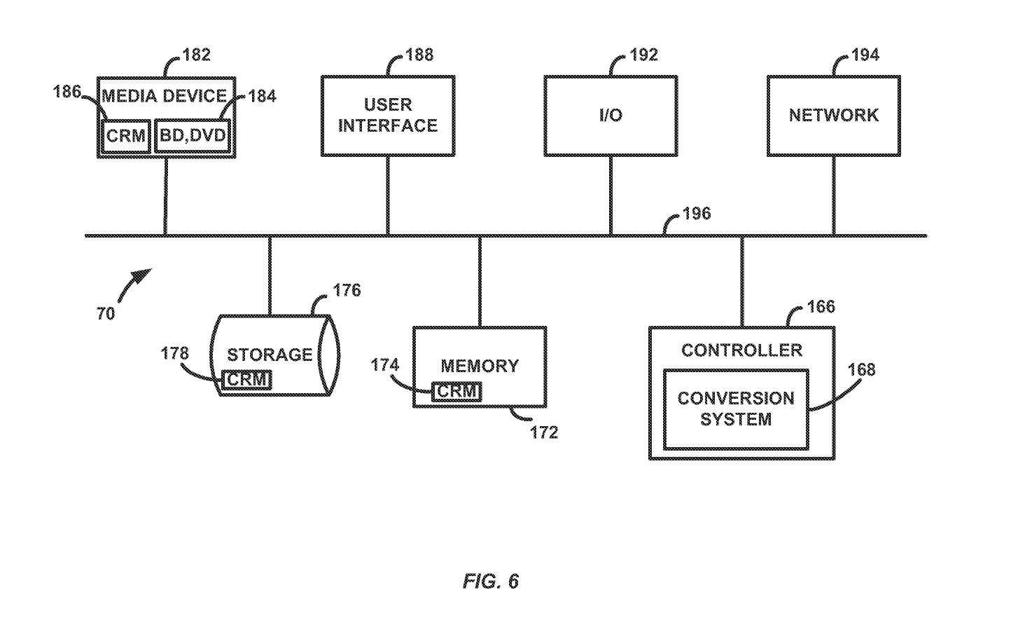

One implementation includes one or more programmable processors and corresponding computing system components to store and execute computer instructions, such as to execute the code that provides the conversion functionality, navigation and user interface, or network functionality. Referring to FIG. 6, a representation of an exemplary computing environment that may be employed is provided.

The computing environment includes a controller 166, a memory 172, storage 176, a media device 182, a user interface 188, an input/output (I/O) interface 192, and a network interface 194. The components are interconnected by a common bus 196. Alternatively, different connection configurations can be used, such as a star pattern with the controller at the center.

The controller 166 includes a programmable processor and controls the operation of the systems and their components for a conversion system 168. The controller 166 loads instructions from the memory 172 or an embedded controller memory (not shown) and executes these instructions to control the system. In its execution, the controller 166 may provide the conversion system as, in part, a software system. Alternatively, this service can be implemented as separate modular components in the controller 166.

Memory 172, which may include non-transitory computer-readable memory 174, stores data temporarily for use by the other components of the system. In one implementation, memory 172 is implemented as RAM. In other implementations, memory 172 also includes long-term or permanent memory, such as flash memory and/or ROM.

Storage 176, which may include non-transitory computer-readable memory 178, stores data temporarily or long-term for use by other components of the system and method, such as for storing data used by the system. In one implementation, storage 176 is a hard disc drive or a solid state drive.

The media device 182, which may include non-transitory computer-readable memory 186, receives removable media and reads and/or writes data to the inserted media. In one implementation, the media device 182 is an optical disc drive or disc burner, e.g., a writable Blu-ray® disc drive 184.

The user interface 188 includes components for accepting user input, e.g., navigational commands or content selections, from the user, and presenting information to the user. In one implementation, the user interface 188 includes a user input device such as a remote control, keyboard, a mouse, audio speakers, and a display. The controller 166 uses input from the user to adjust the operation of the system.

The I/O interface 192 includes one or more I/O ports to connect to corresponding I/O devices, such as displays, external storage or supplemental devices. In one implementation, the ports of the I/O interface 192 include ports such as: DVI ports, HDMI ports, digital audio ports, USB ports, PCMCIA ports, serial ports, and/or parallel ports. In another implementation, the I/O interface 192 includes a wireless interface for wireless communication with external devices. These I/O interfaces may be employed to connect to one or more content playback devices, e.g., network-enabled devices, consumer electronics devices, and the like.

The network interface 194 allows connections with the local network and optionally with external devices and includes a wired and/or wireless network connection, such as an RJ-45 or Ethernet connection or “WiFi” interface (802.11). Numerous other types of network connections will be understood to be possible, including WiMax, 3G or 4G, 802.15 protocols, 802.16 protocols, satellite, Bluetooth®, or the like.

The computing environment may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and within the scope of the present invention. For example, the system and method may receive commands and data entered by a second display, and in this case the operation of the second display and its interaction with the network-enabled device, e.g., consumer electronics device, and network provider may be as described in U.S. patent application Ser. No. 12/982,419, filed Dec. 30, 2010, entitled “WEB BROWSER AS A SECOND DISPLAY CONTROL DEVICE”, and U.S. patent application Ser. No. 12/844,205, filed Jul. 27, 2010, entitled “CONTROL OF IPTV USING SECOND DEVICE”, both of which are owned by the assignee of the present application and herein incorporated by reference in their entireties. The conversion of webpages may produce results to take various settings on the device into account, such as skins, wallpapers, or color schemes, to produce results that visually blend with how other items are displayed on the device.

Accordingly, the present invention is not limited to only those implementations described above.

1. A method of displaying webpages and content on a network-enabled device, comprising:
on a network-enabled device having a navigational scheme, receiving a webpage having web content displayed in a web format and a means for navigation;
converting the display format of the web content to a format appropriate for the network-enabled device and converting the means for navigation to the navigational scheme; and
displaying at least a portion of the converted content.

2. The method of claim 1, wherein the network-enabled device has a predetermined format for display of content, and wherein the converting includes converting the display format of the web content to the predetermined format.

3. The method of claim 2, wherein the converting a means for navigation includes mapping the means for navigation onto a navigational scheme corresponding to an IPTV, media player or game console.

4. The method of claim 1, wherein the format appropriate for the network-enabled device for display of content includes displaying thumbnails of available image, audio, or video files in a matrix, and wherein the converting the display format of the web content to a format appropriate for the network-enabled device includes positioning thumbnails of the available image, audio, or video files from the web page on the matrix, such that a user input device associated with the network-enabled device may be employed to navigate between the thumbnails and to select a thumbnail for display.

5. The method of claim 4, wherein the converting the display format further comprises sizing thumbnails according to their size on the webpage.

6. The method of claim 4, wherein the converting the display format further comprises playing back a slideshow of at least a portion of the images and/or video files on the webpage.

7. The method of claim 4, wherein if a thumbnail of an image, audio or video file is automatically selected on the webpage, then automatically selecting the same image or video on the matrix.

8. The method of claim 1, wherein the format appropriate for the network-enabled device for display of content includes displaying a list of text-based representations of available image, audio, or video files, and wherein the converting the display format of the web content to a format appropriate for the network-enabled device includes positioning the text-based representations of the available image, audio, or video files from the web page in a list, such that a user input device associated with the network-enabled device may be employed to navigate between the representations and to select a representation for display.

9. The method of claim 8, wherein the text based representations are links or menu items.

10. The method of claim 1, wherein the web content includes at least one link, and further comprising following the at least one link to determine additional information about a corresponding content item, and further comprising displaying an indicator of the content item.

11. The method of claim 1, wherein the webpage having web content displayed in a web format includes a plurality of standard links, and wherein the converting includes mapping the standard links to a common section on the predetermined format.

12. The method of claim 11, further comprising arranging the conversion of the means for navigation to the navigational scheme such that the user input device can control targeting of the links.

13. The method of claim 1, wherein if the web content includes text, and the network-enabled device has a 3-D capability, then using the 3-D capability to make the text appear closer to the user than on a display of the network-enabled device.

14. The method of claim 1, wherein if the web content includes text, performing the converting such that the text is prominent and does not wrap around images.

15. The method of claim 1, wherein if a second display is being used to control content on the network-enabled device, then emphasizing a display of content on the network-enabled device corresponding to the content on the second display.

16. The method of claim 1, wherein the converting includes filtering the web content such that the displayed converted content corresponds to only that which is capable of being rendered on the network-enabled device.

17. The method of claim 1, wherein the converting includes filtering the web content such that only a selected type of content is displayed.

18. The method of claim 17, wherein the filtering is in response to a user request.

19. The method of claim 1, wherein the converting uses metadata in the webpage.

20. The method of claim 1, further comprising receiving conversion settings from a server.

21. The method of claim 1, wherein the converting further comprises replacing cursor functionality on a webpage with user input functionality.

22. The method of claim 21, wherein the user input functionality corresponds to remote control functionality.

23. The method of claim 1, wherein the displaying at least a portion of the converted content further comprises displaying any translated content from right to left.

24. The method of claim 1, wherein the displaying at least a portion of the converted content further comprises displaying converted content in a manner native or consistent with a manner the network-enabled device displays other content.

25. The method of claim 1, wherein the converting the means for navigation to the navigational scheme includes mapping a browser NEXT button to a fast-forward button, and a browser back button to a REWIND button.

26. The method of claim 1, wherein the web format of the web page is a standard format having a common set of parameters for conversion, and further comprising converting the display format according to the common set of parameters.

27. The method of claim 26, wherein the standard format is a storefront or wiki.

28. The method of claim 1, wherein the displaying includes displaying a first portion of a web page following the converting, and further displaying a link, and further comprising displaying at least a portion of a remainder of the web page in response to user activation of the link.

29. The method of claim 1, further comprising checking a cache to determine if a portion of the received webpage having web content has been cached, and if so, displaying the cached portion.

30. The method of claim 29, further comprising caching at least a portion of the converted content.

31. The method of claim 30, wherein the portion of the converted content cached corresponds to static elements of the web content.

32. The method of claim 29, further comprising creating the cache by analyzing a browsing history.

33. The method of claim 1, further comprising using device information to determine which of the web content to display.

34. A non-transitory computer-readable medium, comprising instructions for causing a computing device to perform the method of claim 1.

35. A method of displaying webpages and content on a network-enabled device, comprising:
on a network-enabled device, determining characteristics of a user input device;
performing a range request to find out a size of a webpage;
downloading the webpage;
using the determined characteristics of the user input device and device characteristics of the network-enabled device, dynamically translating and transforming the webpage; and
displaying the transformed webpage.

36. The method of claim 35, further comprising segmenting the content inside the webpage by content type.

37. The method of claim 35, wherein the determining characteristics of the user input device is performed by making a backend call to a database or by sending a request to the user input device.

38. The method of claim 35, wherein the dynamically translating and transforming includes rearranging the webpage from a vertical navigation viewing scheme to a horizontal navigation viewing scheme.

39. A method of displaying webpages and content on a network-enabled device, comprising:
receiving notification that a network enabled device has requested a webpage, the network-enabled device having a navigational scheme, and the webpage having web content displayed in a web format and a means for navigation;
converting the display format of the web content to a format appropriate for the network-enabled device and converting the means for navigation to the navigational scheme; and
transmitting at least a portion of the converted content to the network enabled device for display.
